(19) United States
(12) Patent Application Publication
(10) Pub. No.: US 2020/0239336 A1
(43) Pub. Date: Jul. 30, 2020

(54) SYSTEMS AND PROCESSES FOR REMOVING CONTAMINANTS FROM WATER

(71) Applicant: Rickey S. Lutterbach, Long Beach, IN (US)

(72) Inventor: Rickey S. Lutterbach, Long Beach, IN (US)

(21) Appl. No.: 16/774,782

(22) Filed: Jan. 28, 2020

Related U.S. Application Data
(60) Provisional application No. 62/797,516, filed on Jan. 28, 2019.

(51) Int. Cl. C02F 1/42; B01J 41/04; B01J 41/14; B01J 47/024; C08F 212/08

(52) U.S. Cl. CPC C02F 1/42; B01J 41/04; B01J 41/14; C02F 2101/36; C08F 212/08; C02F 2201/006; C02F 2303/16; B01J 47/024

(57) ABSTRACT

Systems and processes for removing contaminants from water. Such a process includes flowing water into each of a plurality of vessels, wherein the water enters each of the vessels through at least one inlet port and exits each of the vessels through multiple outlet ports in a lower base wall of the vessel. The water then flows in fluidic parallel through a plurality of cartridges within each of the vessels. The water enters each of the cartridges through an upper inlet and is contained within the cartridge to exit through a lower outlet thereof that forms a watertight joint with one of the outlet ports of the vessel in which the cartridge is disposed. Each cartridge contains media formed of an ion exchange resin that removes the contaminants from the water.

### CROSS-REFERENCE TO RELATED APPLICATIONS

This application claims the benefit of U.S. Provisional Application No. 62/797,516, filed Jan. 28, 2019, the contents of which are incorporated herein by reference.

### BACKGROUND OF THE INVENTION

The present invention generally relates to systems and processes for performing liquid treatments, as examples, liquid purification to permit an intended use for the liquid, including but not limited to human consumption, bathing, etc. The invention particularly relates to units for use in systems and processes that are capable of purifying water from feedstocks that may be contaminated with perfluoroalkyl and polyfluoroalkyl substances (PFAS), including but not limited to perfluoroalkyl sulfonic acids (PFSA) such as perfluorooctanesulfonic acid (PFOS), perfluorobutanesulfonic acid (PFBS), and perfluorooctanoic acid (PFOA).

Today's environment regarding new and dangerous water contaminants is creating a new breed of dangerous and hazardous man-made chemicals that are overwhelming in the US and the world. The origins of the chemicals come from thousands of products and services used in industrial and commercial applications. As a particular example, the stability and hydrophobic and lipophobic nature of the perfluoroalkyl moiety (CₙF₂ₙ₊₁—) contained in PFAS leads to the widespread use of PFAS as surfactants and in polymers into which the perfluoroalkyl moiety is incorporated. Polymer applications include stain repellents used in textiles and packaging paper for foods. Surfactant applications include foams used to extinguish fires, coatings, and fluoropolymer production.

For the most part, PFAS have escaped the watchful eyes of regulators for many years. More recently, a public backlash has arisen attributable to major health issues spanning a wide range of catastrophic events, resulting in unusable or contaminated ground water, wells, lakes, and public water systems, leading to abandoned neighborhoods and vast depreciation of real estate values.

Based on current thinking and available processes, the elimination of PFAS from water has relied on the use of activated carbon charcoal filtering processes. However, attempting to purify large volumes of water obtained from a wide variety of feedstocks requires the use of massive amounts of activated carbon charcoal filtering media. In addition, though providing a benefit for treating some impurities including sources of turbidity and odors, drawbacks of activated carbon charcoal include low effectiveness, high costs, and maintenance issues that are exacerbated when attempting to process large quantities of remediated water.

A more effective remedy for eliminating PFAS from water involves the use of ion exchange resins (IERs). However, IERs are not well suited for purifying very large volumes of water due to the need for very low process flow rates, typically under 2 gallons per minute (gpm), to be effective for meeting EPA requirements, which most recently set a limit of 70 parts per billion. A flow rate that low is not conducive to processing large volumes of water without incurring very high capital expense.

### BRIEF DESCRIPTION OF THE INVENTION

The present invention provides systems and processes suitable for removing contaminants from water.

According to one aspect of the invention, such a process includes flowing water into each of a plurality of vessels, wherein the water enters each of the vessels through at least one inlet port and exits each of the vessels through multiple outlet ports in a lower base wall of the vessel. The water then flows in fluidic parallel through a plurality of cartridges within each of the vessels. The water enters each of the cartridges through an upper inlet and is contained within the cartridge to exit through a lower outlet thereof that forms a watertight joint with one of the outlet ports of the vessel in which the cartridge is disposed. Each cartridge contains media formed of an ion exchange resin that removes the contaminants from the water.

According to another aspect of the invention, a system includes a plurality of vessels each having a lower base wall, a sidewall, an upper opening, and a lid closing the upper opening to define a cavity within the vessel. Each vessel further has at least one inlet port through which the water enters the vessel and multiple outlet ports in the base wall through which the water exits the vessel. Cartridges are within each vessel and arranged in fluidic parallel. Each cartridge has a lower outlet adapted to form a watertight joint with one of the outlet ports of the vessel in which the cartridge is disposed, an upper inlet through which the water within the vessel enters the cartridge, and a closed sidewall between the inlet and outlet to define an interior that contains the water entering the cartridge through the inlet and defines a flow path through the cartridge between the inlet and the outlet. Media formed of an ion exchange resin is contained within each of the cartridges and removes the contaminants from the water flowing through each of the cartridges.

Technical aspects of systems and processes as described above preferably include the ability to achieve a bedding time within each cartridge below 2 gpm while simultaneously substantially increasing the process flow volume through individual vessels of the system to enable the system to process large volumes of water without incurring very high capital expenses. As such, the proposed system and process significantly decrease the overall cost per treated gallon while significantly decreasing capital costs and maintenance expenses.

Other aspects and advantages of this invention will be appreciated from the following detailed description.

### BRIEF DESCRIPTION OF THE DRAWINGS

FIG. 1 schematically represents a side view of a filter cartridge suitable for use in a system for removing contaminants from water in accordance with a nonlimiting embodiment of the invention.

FIG. 2 schematically represents a top view of a vessel housing multiple filter cartridges of FIG. 1 and adapted for use in a system to remove contaminants from water in accordance with a nonlimiting embodiment of the invention.

FIG. 3 schematically represents a side view of two vessels of the type shown in FIG. 2 that are arranged in fluidic series to remove contaminants in accordance with a nonlimiting embodiment of the invention.

FIGS. 4 and 5 schematically represent top and side views, respectively, of a system containing vessels of the type shown in FIGS. 2 and 3 and adapted to remove contaminants from large volumes of water in accordance with a nonlimiting embodiment of the invention.

FIGS. 6, 7, and 8 are images showing perspective views of cartridges and vessels of the types represented in FIGS. 1 through 5 in accordance with a nonlimiting embodiment of the invention.

FIGS. 9A and 9B in combination schematically represent the system of FIGS. 4 and 5 further modified to include a foam processing tank.

### DETAILED DESCRIPTION OF THE INVENTION

Some of the drawings disclose certain dimensions and materials for various components of a system adapted to remove contaminants in accordance with nonlimiting embodiments of the invention, and such dimensions and materials are believed to be preferred or exemplary, but are otherwise not necessarily limitations to the scope of the invention.

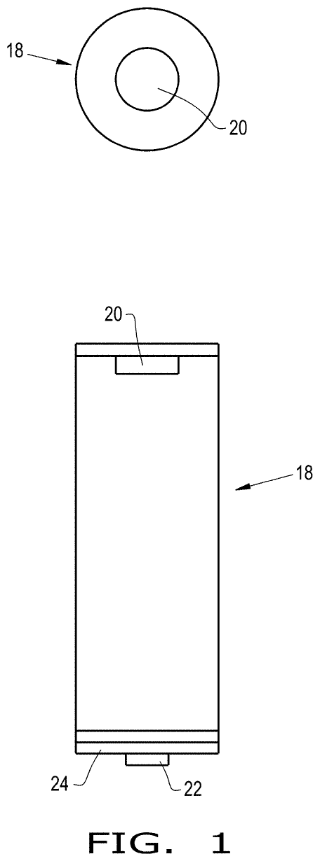

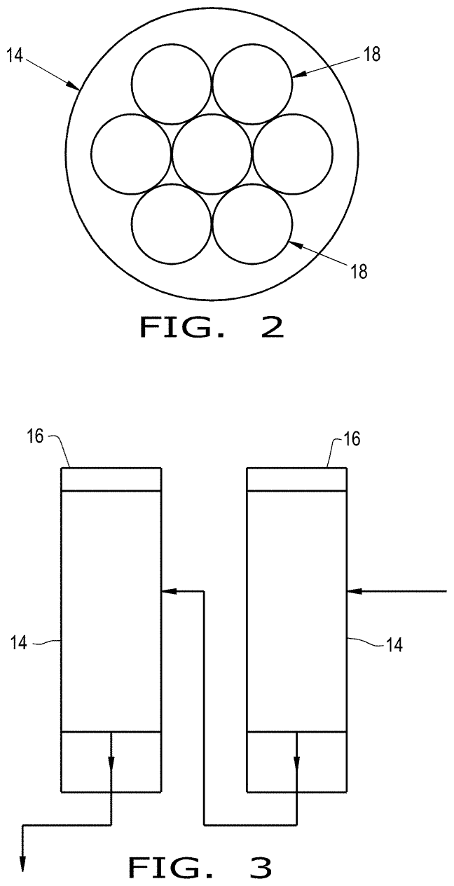

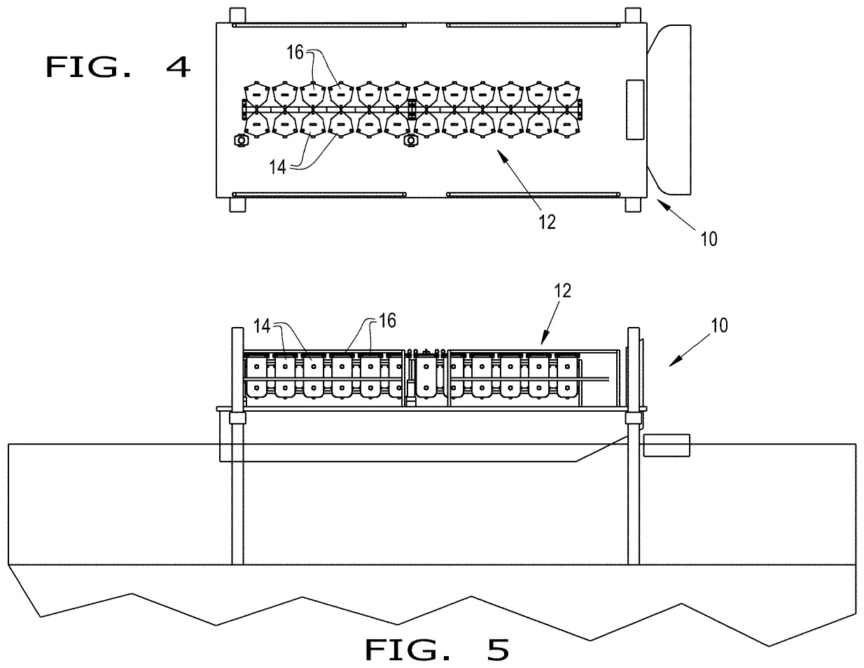

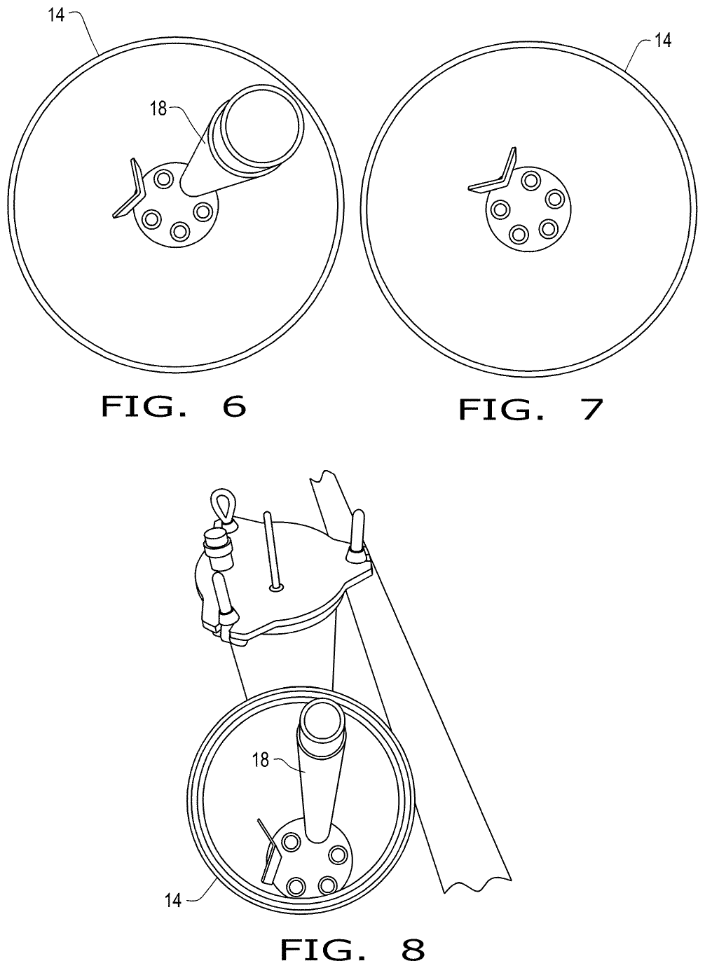

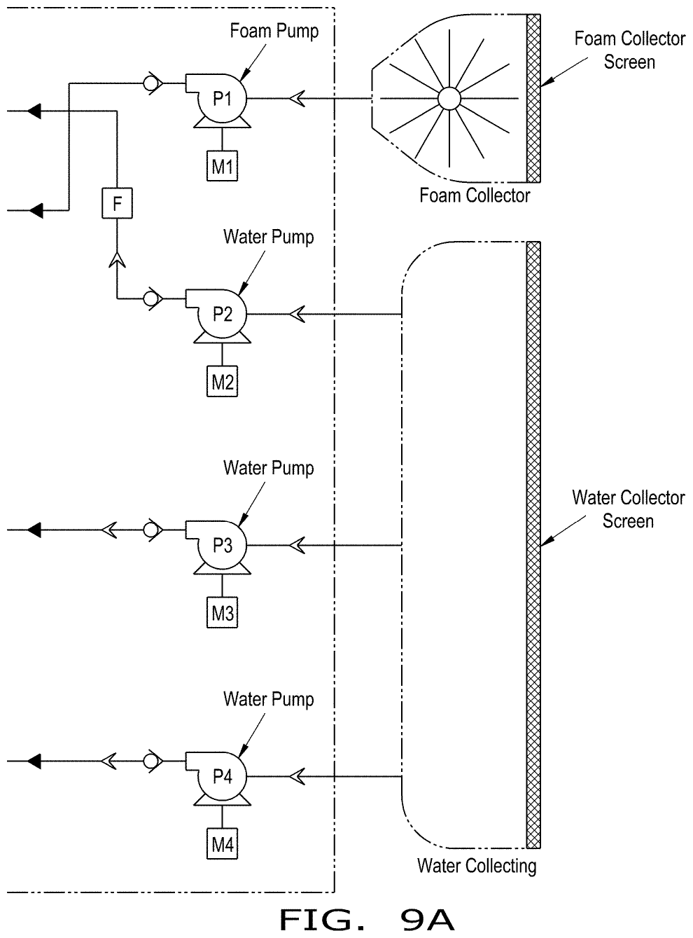

FIGS. 4 and 5 schematically represent top and side views, respectively, of a system 10 that contains an array 12 of individual vessels 14 that in combination are capable of removing contaminants from large volumes of water in accordance with a nonlimiting embodiment of the invention. Nonlimiting examples of the vessels 14 are schematically represented in FIGS. 2 and 3 and physical prototype embodiments of the vessels 14 are shown in FIGS. 6 through 8. The vessels 14 each generally have a cylindrical shape comprising a lower base wall, a tubular sidewall, and an upper opening closed by a lid 16 that in combination define a filter cavity within each vessel 14. The base wall has raised outlet ports (FIGS. 6, 7, and 8) each adapted to form a watertight connection or joint with a cartridge 18, such as of a type represented in FIG. 1. FIG. 2 schematically represents seven cartridges 18 installed in a vessel 14, and FIGS. 6 and 8 show a single cartridge 18 installed in a vessel 14 adapted to receive five cartridges. It is foreseeable that each vessel 14 and its cavity could have a shape other than cylindrical, and could be configured to receive fewer or more cartridges.

As represented in FIG. 1, the cartridges 18 each have an inlet (“hole”) 20 defined in a lid at its upper end through which water within the vessel 14 enters the cartridge 18, and an outlet 22 at its lower end through which the water that entered through the cartridge inlet 20 exits the cartridge 18. The inlet 20 and outlet 22 each may incorporate a 30-micron screen. The lower end of the cartridge 18 includes a grommet 24 for providing the aforementioned watertight joint with one of the outlet ports of the vessel 14. The cartridges 18 within each vessel 14 are arranged in fluidic parallel, and each cartridge 18 has a closed and nonporous sidewall between its inlet 20 and outlet 22 to define a cylindrical-shaped interior that contains the water entering the cartridge 18 through its inlet 20 and defines a flow path through the cartridge 18 between the inlet 20 and outlet 22. FIGS. 1, 2, and 3 disclose dimensions for the vessels 14 and cartridges 18 that are believed to be particularly well suited for creating a flow rate through an amount of an ion exchange resin (not shown) contained in each cartridge 18 to remove contaminants flowing through a system (e.g., 10 in FIGS. 4 and 5) containing the vessels 14 and cartridges 18. As indicated in FIG. 3, contaminated water is introduced through an inlet port in the sidewall of a vessel 14, and exits through a catch basin that serves as a manifold to collect water exiting the cartridges 18 through the outlet ports of the vessel 14. FIG. 1 represents the flow path through a cartridge 18 as being downward from its inlet 20 to its outlet 22, such that water entering a vessel 14 initially flows upward to the cartridge inlets 22 before flowing downward to the vessel outlet ports.

FIG. 3 represents two vessels 14 connected in series, though it is foreseeable that water could be processed through a single vessel 14 or through a series comprising more than two vessels 14 in series, depending on the particular requirements and the contamination level of the water. Placing vessels 14 in series serves to increase the water contact time with the ion exchange resin by forcing the water to pass through at least two cartridges 18. As a nonlimiting example, a flow rate for a vessel 14 equipped with seven cartridges 18 can obtain a flow rate of about twelve to fifteen gallons per minute, while still using a flow rate within an individual cartridge 18 that is sufficiently low to enable the resin to be effective in removing the targeted contaminants.

The ion exchange resin has a composition and physical characteristics to promote the ability of the resin to remove contaminants from water at the flow rates within the cartridges. Particular but nonlimiting examples of ion exchange resins are polystyrenic materials commercially available from Purolite® under the names A592E and PFA694E. The former is described by Purolite® as a polystyrenic macroporous anion resin capable of removing perfluoroalkyl substances, and the latter as a polystyrenic gel capable of removing perfluoroalkyl and polyfluoroalkyl substances. In particular, A592E is described as a macroporous polystyrene crosslinked with divinylbenzene and in the form of spherical beads having a particle size range of 300 to 1200 micrometers, a maximum uniformity coefficient of 1.7, and a specific gravity of 1.08, and PFA694E is described as a polystyrene crosslinked with divinylbenzene and in the form of spherical beads having a mean diameter of 675+/−75 micrometers, a maximum uniformity coefficient of 1.3, and a specific gravity of 1.03.

Ion exchange resins such as A592E and PFA694E ordinarily require very low process flow rates of under 2 gpm to be most effective for removing perfluoroalkyl and polyfluoroalkyl substances (PFAS). The configurations of the vessels 14 and cartridges 18 shown in the drawings enable these materials in their bead form to process very large volumes of water while not exceeding their effective flow rates, and allow for “bedding” times of 2 gpm and less. Relevant dimensional characteristics are believed to include a diameter-to-height aspect ratio of about 1:4 for each cartridge interior, and a diameter-to-height aspect ratio of about 3:4 for vessel interiors containing five cartridges 18, though lesser or greater aspect ratios are foreseeable.

It is believed that ion exchange media of the types described above are capable of PFAS reductions to nondetectable levels, e.g., less than 70 parts per billion, and have an effective life of more than one year. Significantly, when utilized in the system 10 comprising the cartridges 18 arranged in fluidic parallel within the array of vessels 14, very high process flow volumes to enable the processing of large volumes of water, while simultaneously providing a bedding time of well under 2 gpm to enable the ion exchange resin to be effective. Once deemed to be no longer effective, the media can be removed from a cartridge 18 and incinerated in an economical and environmentally safe manner.

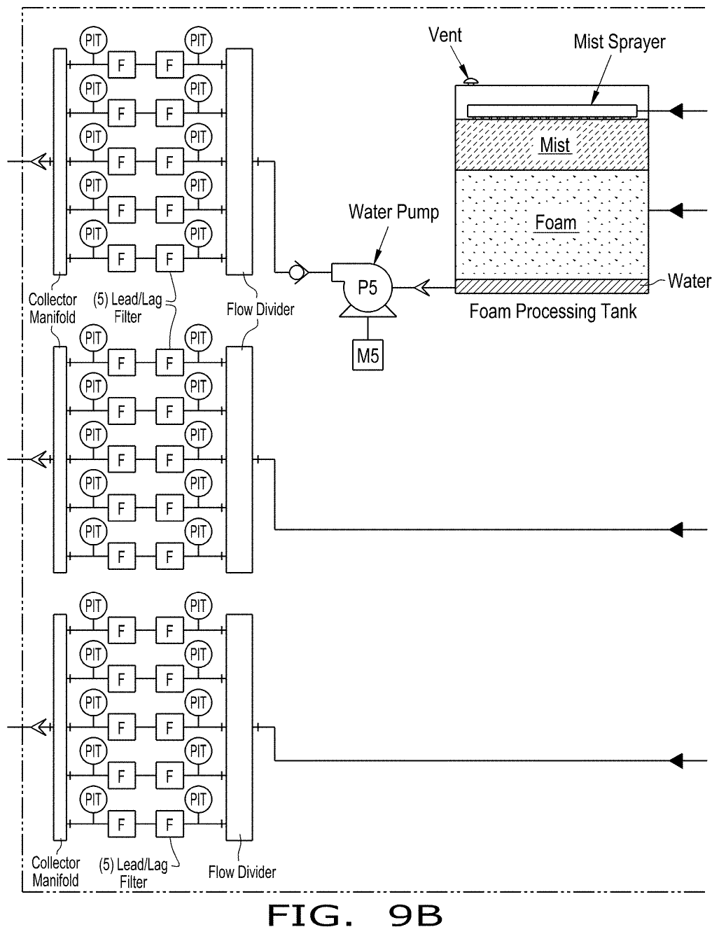

FIGS. 9A and 9B in combination schematically represent a system of the type represented in FIGS. 4 and 5 as further modified to include a foam processing tank, which is configured to process a foam that may be present at the surface of the water source being treated, for example, foam present on the surface of a lake or river. Such a foam may be a byproduct of PFAS chains in the water surface and form as a result of the water being agitated, for example, natural conditions such as winds and water currents. The foam may essentially be entirely PFAS, possibly with other components that the agitation process may pull into the foam from the water source, such as other surface contaminants or total dissolved solids (TDS) that may be captured by the foam. It has been reported that the foam may have some of the highest concentrations of PFAS in a body of water. The foam processing tank includes a mist sprayer that may use water from the same water source being treated. The sprayer is used to convert the foam back into a liquid state that collects as “water” at the bottom of the foam processing tank. The water fed to the sprayer may be combined with a bio-safe agricultural surfactant wetting agent to promote the conversion of the foam to a liquid state. The inclusion of the foam processing tank is intended to enable PFAS present in foam on a body of water to be processed by the system, while reducing or eliminating the likelihood that foam will physically enter the vessels and cartridges of the system, which could lead to disruption of the flow therein. As indicated in FIGS. 9A and 9B, the entire system may be placed on a barge operating on the body of water being treated.

While the invention has been described in terms of a particular embodiment, it should be apparent that alternatives could be adopted by one skilled in the art. For example, the system 10 and its components could differ in appearance and construction from the embodiment described herein and shown in the drawings, and functions of certain components of the system 10 could be performed by components of different construction but capable of a similar (though not necessarily equivalent) function, process parameters could be modified, and appropriate materials could be substituted for those noted. As such, it should be understood that the above detailed description is intended to describe the particular embodiment represented in the drawings and certain but not necessarily all features and aspects thereof, and to identify certain but not necessarily all alternatives to the represented embodiment and its described features and aspects. As a nonlimiting example, the invention encompasses additional or alternative embodiments in which one or more features or aspects of the disclosed embodiment could be eliminated. Accordingly, it should be understood that the invention is not necessarily limited to any embodiment described herein or illustrated in the drawings, and the phraseology and terminology employed above are for the purpose of describing the illustrated embodiment and do not necessarily serve as limitations to the scope of the invention. Therefore, the scope of the invention is to be limited only by the following claims.

1. A process of removing contaminants from water, the process comprising:
flowing water from a source into each of a plurality of vessels, the water entering each of the vessels through at least one inlet port and exiting each of the vessels through multiple outlet ports in a lower base wall of the vessel; and
flowing the water in fluidic parallel through a plurality of cartridges within each of the vessels, the water entering each of the cartridges through an upper inlet and being contained within the cartridge to exit through a lower outlet thereof that forms a water-tight joint with one of the outlet ports of the vessel in which the cartridge is disposed, each of the cartridges containing media formed of an ion exchange resin that removes the contaminants from the water.

2. The process according to claim 1, wherein the ion exchange resin is a polystyrenic material capable of removing perfluoroalkyl substances from the water.

3. The process according to claim 2, wherein the polystyrenic material is a macroporous polystyrene crosslinked with divinylbenzene and the media are spherical beads having a particle size range of 300 to 1200 micrometers, a maximum uniformity coefficient of 1.7, and a specific gravity of 1.08.

4. The process according to claim 2, wherein the polystyrenic material is a polystyrene crosslinked with divinylbenzene and the media are spherical beads having a mean diameter of 675+/−75 micrometers, a maximum uniformity coefficient of 1.3, and a specific gravity of 1.03.

5. The process according to claim 1, wherein the media are spherical beads.

6. The process according to claim 1, wherein the vessels are fluidically coupled in pairs so that the water flows through a first of a pair of the vessels and then enters a second of the pair of the vessels.

7. The process according to claim 1, wherein the cavities of the vessels each have a diameter-to-height aspect ratio of about 3:4.

8. The process according to claim 1, wherein the interiors of the cartridges each have a diameter-to-height aspect ratio of about 1:4.

9. The process according to claim 1, wherein the media reduces perfluoroalkyl substances in the water to a level of less than 70 parts per billion.

10. The process according to claim 1, wherein the vessels process a large volume of water while simultaneously providing a bedding time within each of the cartridges of less than 2 gpm.

11. The process according to claim 1, further comprising collecting a foam from the source of the water, converting the foam into a liquid, and flowing the liquid into at least some of the plurality of vessels.

12. The process according to claim 1, further comprising removing and incinerating the media.

13. A system for removing contaminants from water obtained from a source, the system comprising:
a plurality of vessels each having a lower base wall, a sidewall, an upper opening, and a lid closing the upper opening to define a cavity within the vessel, each vessel further having at least one inlet port through which the water enters the vessel and multiple outlet ports in the base wall through which the water exits the vessel;
a plurality of cartridges within each of the vessels and arranged in fluidic parallel, each of the cartridges having a lower outlet adapted to form a water-tight joint with one of the outlet ports of the vessel in which the cartridge is disposed, an upper inlet through which the water within the vessel enters the cartridge, and a closed sidewall between the inlet and outlet to define an interior that contains the water entering the cartridge through the inlet and define a flow path through the cartridge between the inlet and the outlet; and
media formed of an ion exchange resin that is contained within each of the cartridges and removes the contaminants from the water flowing through each of the cartridges.

14. The system according to claim 13, wherein the media are spherical beads.

15. The system according to claim 13, wherein the ion exchange resin is a polystyrenic material capable of removing perfluoroalkyl substances from the water.

16. The system according to claim 15, wherein the polystyrenic material is a macroporous polystyrene crosslinked with divinylbenzene and the media are spherical beads having a particle size range of 300 to 1200 micrometers, a maximum uniformity coefficient of 1.7, and a specific gravity of 1.08.

17. The system according to claim 15, wherein the polystyrenic material is a polystyrene crosslinked with divinylbenzene and the media are spherical beads having a mean diameter of 675+/−75 micrometers, a maximum uniformity coefficient of 1.3, and a specific gravity of 1.03.

18. The system according to claim 13, wherein the vessels are fluidically coupled in pairs so that the water flows through a first of a pair of the vessels and then enters a second of the pair of the vessels.

19. The system according to claim 13, wherein the cavities of the vessels each have a diameter-to-height aspect ratio of about 3:4.

20. The system according to claim 13, wherein the interiors of the cartridges each have a diameter-to-height aspect ratio of about 1:4.

21. The system according to claim 13, wherein the media reduces perfluoroalkyl substances in the water to a level of less than 70 parts per billion.

22. The system according to claim 13, further comprising means for collecting a foam from the source of the water, converting the foam into a liquid, and flowing the liquid into at least some of the plurality of vessels.
